(19) United States
(12) Patent Application Publication
(10) Pub. No.: US 2018/0269446 A1
(43) Pub. Date: Sep. 20, 2018

(54) Energy Storage Module

(71) Applicant: Bayerische Motoren Werke Aktiengesellschaft, Muenchen (DE)

(72) Inventors: Tuncay IDIKURT, Muenchen (DE); Alexander MUCK, Muenchen (DE); Philip KOTTER, Muenchen (DE)

(21) Appl. No.: 15/986,893

(22) Filed: May 23, 2018

Related U.S. Application Data
(63) Continuation of application No. PCT/EP2016/079393, filed on Dec. 1, 2016.

(30) Foreign Application Priority Data
Dec. 15, 2015 (DE) 10 2015 225 188.8

(51) Int. Cl. H01M 2/10; H01M 10/625; H01M 10/6555; B60L 11/18

(52) U.S. Cl. CPC H01M 2/1077; H01M 10/625; H01M 2220/20; B60L 11/1879; H01M 10/6555

(57) ABSTRACT

An energy storage module includes a plurality of cuboid-like energy storage cells, which in a longitudinal direction of the energy storage module are arranged in a row one behind the other and are electrically connected to one another. Each of the energy storage cells has two outer walls that are of the same size and are spaced apart from one another, and each has four narrow connecting walls connecting the outer walls to one another, wherein in each case, a frame-like intermediate element is arranged between two successive energy storage cells, as a result of which two mutually facing outer walls of two successive energy storage cells are spaced apart from one another.

### CROSS REFERENCE TO RELATED APPLICATIONS

This application is a continuation of PCT International Application No. PCT/EP2016/079393, filed Dec. 1, 2016, which claims priority under 35 U.S.C. § 119 from German Patent Application No. 10 2015 225 188.8, filed Dec. 15, 2015, the entire disclosures of which are herein expressly incorporated by reference.

### BACKGROUND AND SUMMARY OF THE INVENTION

The present invention relates to an energy storage module having a plurality of cuboid-like energy storage cells which are arranged in a row one behind another in a longitudinal direction of the energy storage module and are electrically connected to one another, wherein each of the energy storage cells has two outer walls of identical size spaced apart from each other and four narrow connecting walls connecting the outer walls to one another.

High voltage storage devices of hybrid or electric vehicles customarily consist of a plurality of electrically interconnected energy storage modules. Each of the energy storage modules in turn consists of a plurality of electrically interconnected energy storage cells. In the case of many hybrid or electric vehicles, the individual energy storage cells are substantially cuboid-like and are arranged nested in a row one behind another. During operation of a high voltage storage device, the individual energy storage cells are frequently charged and discharged. The chemical processes taking place in the individual energy storage cells during the charging cycles produce mechanical forces which are transmitted to the walls of the individual energy storage cells.

In order to prevent or to limit bulging of the housings of the individual energy storage cells of an energy storage module, the individual energy storage cells are customarily “clamped together” in the longitudinal direction of the energy storage module. For this purpose, the individual energy storage cells of an energy storage module are arranged between two of what are referred to as “clamping plates” which are connected to each other via tie rods. During the production of an energy storage module, first of all the individual energy storage cells are arranged one behind another in nested form to form a “cell pack”, wherein the individual energy storage cell housings can be adhesively bonded to one another. The cell pack is introduced here between two clamping plates. The two clamping plates are subsequently compressed in a distance-controlled and force-monitored manner with the cell pack located in between, i.e. the cell pack is compressed by a predetermined distance and with a predetermined minimum force. Subsequently, in order to maintain this state, tie rods are welded onto the two clamping plates, and therefore the cell pack remains permanently clamped together.

Up until now, the starting point has been that the bracing of the cell pack is required in order to counter aging processes (in particular what is referred to as the lithium plating) in the individual energy storage cells.

It is the object of the invention to provide an energy storage module which is designed in an alternative manner and can be assembled simply and in as scalable a manner as possible.

This and other objects are achieved according to the invention by an energy storage module having a plurality of cuboid-like energy storage cells which are arranged in a row one behind another in a longitudinal direction of the energy storage module and are electrically connected to one another, wherein each of the energy storage cells has two outer walls of identical size spaced apart from each other, and four narrow connecting walls connecting the outer walls to one another. A frame-like intermediate element is in each case arranged between two successive energy storage cells of the energy storage module, as a result of which two mutually facing outer walls of two successive energy storage cells of the energy storage module are spaced apart from each other.

The starting point of the invention is the finding that, contrary to the previous opinion in the art, bracing of the cell pack of an energy storage module is not absolutely required, that is to say that it is entirely possible to allow the housings of the individual energy storage cells of a (high voltage) energy storage module to bulge during operation.

A (high voltage) energy storage module according to the invention has a plurality of cuboid-like energy storage cells which are arranged nested in a row one behind another in a longitudinal direction of the energy storage module and are connected electrically to one another. Individual ones, or all, of the energy storage cells of the energy storage module, can be connected, for example, in a row and/or partially parallel. Each of the energy storage cells has in each case two outer walls of identical size and spaced apart from one another. The two outer walls form the largest outer surfaces of an energy storage cell. The outer walls are perpendicular to the longitudinal direction of the energy storage module. An energy storage cell furthermore has four narrow connecting walls connecting the outer walls to one another. A first pair of the connecting walls forms a lower side or upper side of the energy storage cell(s). A second pair of the connecting walls forms the left or right end side of the energy storage cell(s).

A core concept of the invention consists in that a respective frame-like intermediate element is arranged in each case between two successive energy storage cells of an energy storage module, as a result of which two mutually facing outer walls of two successive energy storage cells are spaced apart from each other. The intermediate element therefore acts to a certain extent as a “spacer” between two successive energy storage cells.

The intermediate element can be designed in the manner of a rectangle (or substantially in the manner of a rectangle) and substantially corresponds in respect of its size to the size of the two largest surfaces of the individual energy storage cells.

According to a development of the invention, the frame-like intermediate element has a central opening which can likewise be designed, for example, rectangularly. The central opening forms a gap-like intermediate space between the two energy storage cells adjoining the intermediate element, into which space the mutually facing outer walls of two successive energy storage cells, i.e. the energy storage cells directly adjoining the intermediate element, can bulge.

In contrast to the energy storage modules as are known from conventional high voltage storage devices of hybrid or electric vehicles, bulging of the housing walls of the individual energy storage cells of an energy storage module is therefore consciously permitted.

The gap-like intermediate space formed by the central opening of the intermediate element can be an air gap.

Alternatively thereto, the gap-like intermediate space can be entirely or partially filled with a thermally conductive material which contacts the mutually facing outer walls of the two energy storage cells adjoining the respective intermediate element and therefore promotes an equalization of the temperature between individual energy storage cells, i.e. a flow of heat from the housing of one energy storage cell to the housing of the adjacent energy storage cell of an energy storage module.

Alternatively or additionally, the gap-like intermediate space can also be completely or partially filled with an electrically insulating material which contacts the mutually facing outer walls of the two energy storage cells adjoining the respective intermediate element.

Use is preferably made of a material which is both electrically insulating and also readily conductive thermally, i.e. has a high coefficient of thermal conductivity.

According to a development of the invention, the individual intermediate elements each have at least one pair of clamping surfaces which are preferably of flexurally elastic design and which protrude from the frame-like intermediate element in the longitudinal direction of the energy storage module. Two spaced-apart, mutually opposed connecting walls of an energy storage cell (e.g. the abovementioned left or right end wall) can be clamped between such a pair of clamping surfaces of the intermediate element. It is thereby ensured that the individual energy storage cells are positioned in a predetermined manner with respect to the individual intermediate elements. Each of the intermediate elements preferably has at least two pairs of (flexurally elastic) clamping surfaces. For example, it can be provided that a first pair of clamping surfaces lies laterally against the two end surfaces of the energy storage cell and a second pair of clamping surfaces lies against a lower side or against an upper side of an energy storage cell. It is thereby ensured that the individual energy storage cells are positioned unambiguously with respect to the individual intermediate elements not only in the transverse direction, but also in the vertical direction.

The intermediate elements of an energy storage module are preferably of identical design without exception. It can be provided here that an intermediate element is connected to the two adjoining intermediate elements in the longitudinal direction. The intermediate elements therefore form a type of “framework” into which or between which the individual energy storage cells are fitted.

The connecting elements of the intermediate elements are preferably formed in pairs as clip elements or latching elements, which permits simple clipping together of a plurality of intermediate elements nested one behind another.

For example, it can be provided that each of the intermediate elements in each case has at least one tongue-like latching element and in each case at least one receiving element which is provided to accommodate a tongue-like latching element of another intermediate element. The tongue-like latching element of the other intermediate element can be or is latched in a form-fitting manner into the receiving element.

According to a development of the invention, the energy storage module furthermore has a front end plate and a rear end plate. The end plates correspond in respect of their arrangement to the “end-side” clamping plates known from conventional energy storage modules. The end plates of the energy storage module according to the invention each have connecting elements (e.g. tongue-like latching elements and/or receiving elements). Connecting elements of a front end plate of the energy storage module are connected to a “first intermediate element of the cell pack” and connecting elements of a rear end plate of the energy storage module are connected to a “final intermediate element of the cell pack”.

As already indicated, the individual energy storage cells of the energy storage module according to the invention are arranged one behind another in a row in a manner substantially free from prestress. In contrast to conventional energy storage modules, the individual energy storage cells are therefore not specifically or not substantially braced against one another mechanically.

The individual intermediate elements and/or the two end plates of the energy storage module according to the invention can be produced, for example, from plastic. The intermediate elements and the two end plates can be injection molded parts.

The invention not only relates to an energy storage module per se, but also to a high voltage storage device for vehicles and to a vehicle with such a high voltage storage device which is formed by a plurality of electrically interconnected energy storage modules, as have been described above.

According to a development of the invention, the two end plates of the energy storage module according to the invention each have at least one fastening flange, via which the end plates and therefore the entire storage module is fastened (e.g. via a screw or bolt connection) to another component, e.g. to a housing of the energy storage module or to a housing of a high voltage storage device in which a plurality of energy storage modules are accommodated.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of an intermediate element of an energy storage module according to an embodiment of the invention.

FIG. 2 is a perspective view of an intermediate element clamped onto an energy storage cell.

FIG. 3 is a perspective view of a “framework” of a plurality of intermediate elements clipped together.

FIG. 4 is a perspective view of a cell pack with intermediate elements.

FIG. 5 is a perspective view of an end plate of a cell pack.

FIG. 6 is a perspective view of an energy storage module according to an embodiment of the invention.

### DETAILED DESCRIPTION OF THE DRAWINGS

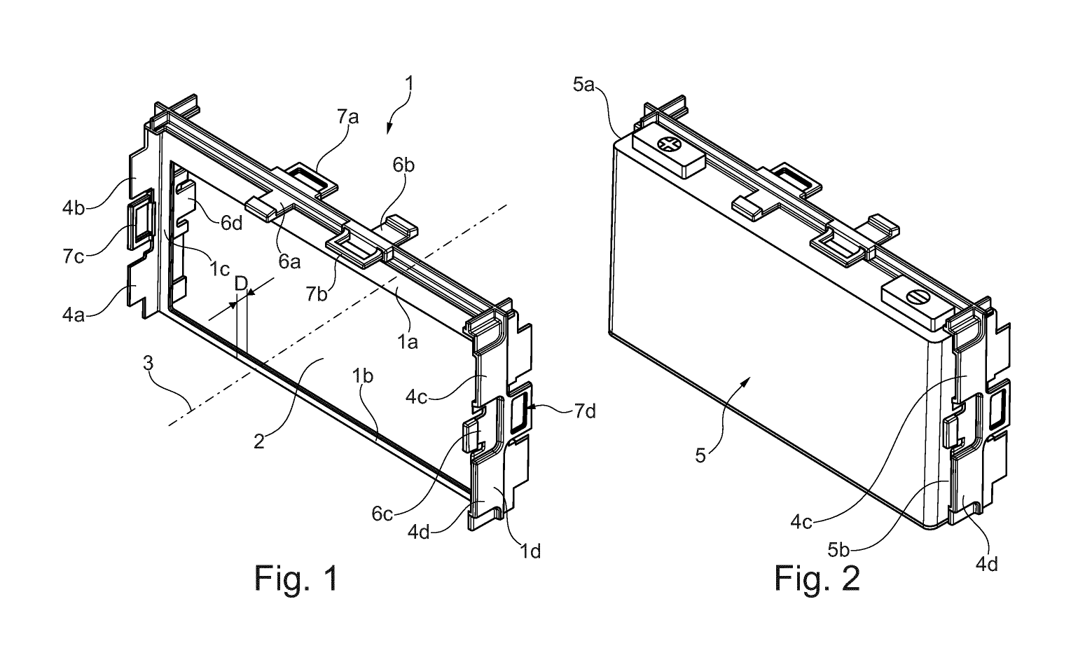

FIG. 1 shows an intermediate element 1 which substantially has the form of a frame of rectangular design. The intermediate element 1 or the rectangular frame has a central rectangular (through) opening 2. The intermediate element 1 can be produced, for example, from plastic in the form of an injection molded part. It acts as a “spacer” between two successive energy storage cells of an energy storage module (cf. FIG. 6). The wall thickness D of the intermediate element can be, for example, within the range of 1 to 10 mm, preferably within the range of between 2 and 8 mm.

The intermediate element has an upper frame portion 1a, a lower frame portion 1b, a left frame portion 1c and a right frame portion 1d.

Clamping surfaces 4a, 4b, 4c, 4d which are in each case flexurally elastic and between which an energy storage cell 5 (cf. FIG. 2) can be clamped protrude in the longitudinal direction 3 of the energy storage module (cf. FIG. 6) from the two frame portions 1c, 1d. The clamping surfaces 4a, 4d and 4b, 4c are arranged in pairs, wherein side surfaces 5a, 5b of an energy storage cell 5 can be clamped between the clamping surfaces 4a-4d (cf. FIG. 2).

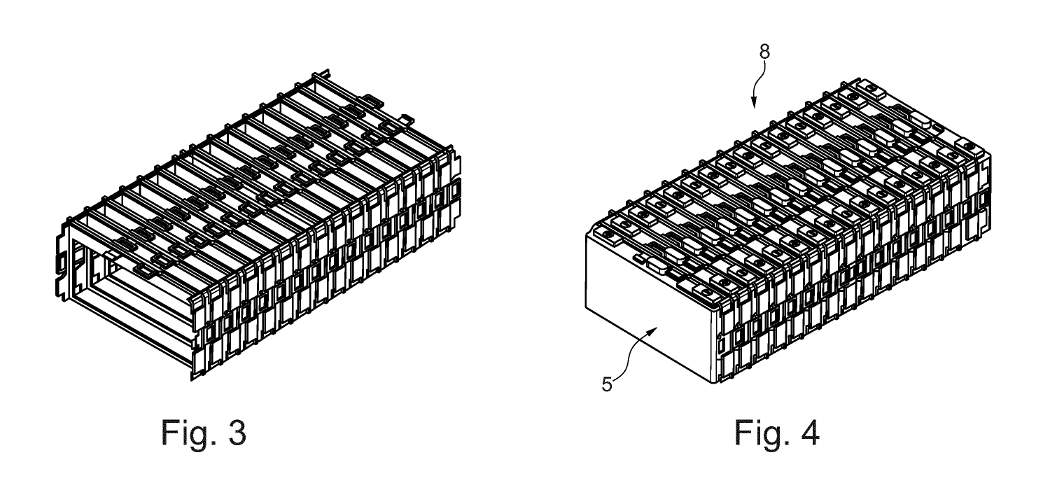

The intermediate elements 1 furthermore have connecting elements which are designed as clip elements or latching elements via which a plurality of intermediate elements can be clipped together to form a framework of intermediate elements, as illustrated in FIG. 3.

The connecting elements protrude in the longitudinal direction 3 of the energy storage module from the main plane of the intermediate element 1, i.e. substantially perpendicularly from the frame plane, formed by the frame portions 1a-1d, of the intermediate element 1.

Individual parts of the connecting elements are designed as tongue-like latching elements 6a, 6b, 6c. Other parts of the connecting elements are designed as U- or hoop-shaped receiving elements 7a-7d. The tongue-like latching elements 6a-6d interact with the complementarily arranged receiving elements 7a-7d of another intermediate element 1. This is seen best by way of the plugged-together framework of intermediate elements shown in FIG. 3.

Owing to the complementary arrangement of the tongue-like latching elements 6a-6d and of the receiving elements 7a-7d, the tongue-like latching elements of an intermediate element can be clipped or latched in each case into an associated receiving element of an adjacent intermediate element. A modular construction can thereby be produced very simply.

FIG. 2 shows an energy storage cell 5 which is clamped between the clamping surfaces 4a-4d of the intermediate element 1 shown in FIG. 1.

FIG. 3 shows the already repeatedly mentioned framework of clipped-together intermediate elements.

FIG. 4 shows a cell pack 8 consisting of a plurality of energy storage cells and intermediate elements arranged in between.

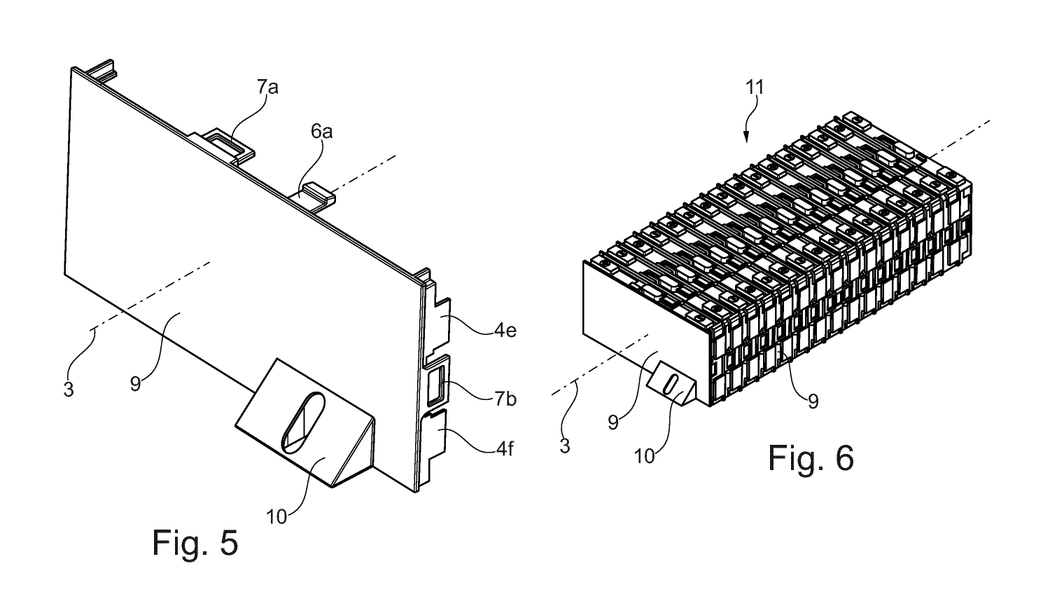

FIG. 5 shows an end plate 9 for a cell pack, as illustrated in FIG. 4. The end plate 9 has, analogously to the intermediate elements 1, clamping surfaces 4e, 4f between which a frontmost or a rearmost energy storage cell of the cell pack 8 (cf. FIG. 4) can be clamped. Furthermore, latching elements, of which only the latching element 6a can be seen here, and receiving elements 7a, 7b, into which latching elements of a next intermediate element can be clipped, protrude in the longitudinal direction 3 of the energy storage module from the cell pack.

The end plate 9 furthermore has a fastening flange 10 via which the end plate 9, and therefore the entire energy storage module 11 shown in FIG. 6, can be firmly screwed to another component, e.g. to a housing (not illustrated specifically here) of the energy storage module 11 or to a housing of a high voltage storage device which contains a plurality of such energy storage devices 11.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An energy storage module, comprising:
a plurality of cuboid-like energy storage cells arranged in a row one behind another in a longitudinal direction of the energy storage module and electrically connected to one another, wherein
each of the energy storage cells has two outer walls that are of a same size and are spaced apart from one another, and each has four narrow connecting walls that connect the outer walls to one another; and
a frame-like intermediate element arranged, in each case, between two successive energy storage cells of the energy storage module, whereby two mutually facing outer walls of two successive energy storage cells of the energy storage module are spaced apart from one another.

2. The energy storage module as claimed in claim 1, wherein
the frame-like intermediate element has a central opening which forms a gap-like intermediate space between the energy storage cells adjoining said opening, into which space the mutually facing outer walls of two successive energy storage cells can bulge.

3. The energy storage module as claimed in claim 2, wherein the gap-like intermediate space is an air gap.

4. The energy storage module as claimed in claim 2, wherein
the gap-like intermediate space is entirely or partially filled with a thermally conductive material which contacts the mutually facing outer walls of the two energy storage cells adjoining the respective intermediate element.

5. The energy storage module as claimed in claim 2, wherein
the gap-like intermediate space is entirely or partially filled with an electrically insulating material which contacts the mutually facing outer walls of the two energy storage cells adjoining the respective intermediate element.

6. The energy storage module as claimed in claim 2, wherein the intermediate element is designed substantially in a rectangular shape.

7. The energy storage module as claimed in claim 2, wherein the central opening is designed substantially in a rectangular shape.

8. The energy storage module as claimed in claim 1, wherein
the intermediate element has a pair of clamping surfaces which protrude from the frame-like intermediate element in the longitudinal direction of the energy storage module, wherein two spaced apart, mutually opposite connecting walls of an energy storage cell are clamped between the clamping surfaces.

9. The energy storage module as claimed in claim 1, wherein
individual or all of the intermediate elements of the energy storage module are of identical design, wherein an intermediate element is connected to the adjacent two intermediate elements in the longitudinal direction via connecting elements.

10. The energy storage module as claimed in claim 9, wherein
the connecting elements are clip elements or latching elements.

11. The energy storage module as claimed in claim 1, wherein
each of the intermediate elements has at least one tongue-like latching element, and has at least one receiving element provided for latching into place a tongue-like latching element of another intermediate element.

12. The energy storage module as claimed in claim 1, wherein
the energy storage module has a front and a rear end plate,
the front and rear end plates in each case have connecting elements,
the connecting elements of the front end plate are latched to a first of the intermediate elements, and connecting elements of the rear end plate are latched to a last of the intermediate elements of the energy storage module.

13. The energy storage module as claimed in claim 1, wherein
the energy storage cells of the energy storage module are arranged in a row one behind another in a substantially unbraced manner.

14. The energy storage module as claimed in claim 1, wherein
the intermediate elements are made of plastic.

15. The energy storage module as claimed in claim 12, wherein
the intermediate elements and/or the end plates are made of plastic.

16. The energy storage module as claimed in claim 12, wherein
the front and rear end plates each have a fastening flange for fastening the end plates and the energy storage module to another component.

17. The energy storage module as claimed in claim 16, wherein the other component is a housing of the energy storage module or a housing of a high voltage storage device.

18. A vehicle with a high voltage storage device formed by a plurality of electrically interconnected energy storage modules as claimed in claim 1.

19. The vehicle as claimed in claim 18, wherein
each energy storage module has a front and a rear end plate, and
the front and rear end plates in each case have connecting elements, wherein the connecting elements of the front end plate are latched to a first of the intermediate elements, and connecting elements of the rear end plate are latched to a last of the intermediate elements of the energy storage module.

20. The vehicle as claimed in claim 19, wherein
the front and rear end plates each have a fastening flange for fastening the end plates and the energy storage module to another component.
